(19) United States
(12) Patent Application Publication
(10) Pub. No.: US 2023/0392936 A1
(43) Pub. Date: Dec. 7, 2023

(54) METHOD AND APPARATUS FOR DETERMINING LINGERING COMMUNICATION INDICATORS

(71) Applicant: HERE GLOBAL B.V., Eindhoven (NL)

(72) Inventor: Donta WHITE, Racine, WI (US)

(73) Assignee: HERE GLOBAL B.V., EINDHOVEN (NL)

(21) Appl. No.: 17/830,180

(22) Filed: Jun. 1, 2022

(51) Int. Cl. G01C 21/32; G01C 21/00; G01C 21/36

(52) U.S. Cl. CPC G01C 21/32; G01C 21/3815; G01C 21/3841; G01C 21/3614

(57) ABSTRACT

A method, apparatus, and user interface for a lingering communication detection system comprising obtaining data of at least one end user electronic communication and determining a lingering communication indicator based on the obtained data, identifying one or more road segments, and associating the determined indicator with one or more identified road segments to update a map layer of a geographic database.

### TECHNOLOGICAL FIELD

An example embodiment relates generally to a method, apparatus, computer readable storage medium, user interface and computer program product for determining lingering communication indicators and, more particularly, for determining vehicle lingering communication indicators based upon end user electronic communication data.

### BACKGROUND

Modern vehicles include a plurality of different types of sensors for collecting a wide variety of information. These sensors include location sensors, such as global positioning system (GPS) sensors, configured to determine the location of the vehicle. Based upon the location of the vehicle, a variety of navigational, mapping and other services may be provided for manually driven vehicles as well as the provision of navigation and control of autonomous or semi-autonomous vehicles. Other examples of sensors include cameras or other imaging sensors that capture images of the environment including objects in the vicinity of the vehicle. The images that are captured may be utilized to determine the location of the vehicle with more precision. A more precise determination of the vehicle location may be useful in conjunction with the provision of navigational, mapping and other informational services for a manually driven vehicle. Additionally, the more precise determination of the vehicle location may provide for the improved navigation and control of an autonomous or semi-autonomous vehicle by taking into account the location of other objects, such as other vehicles, in proximity to the vehicle carrying the sensors.

The sensors on board vehicles therefore collect a wide variety of data that may be utilized for various purposes. However, these sensors currently on-board vehicles do have limitations and do not provide all of the different types of information that would be useful in various applications. One specific example of a current limitation is in the generation of route guidance and automated vehicle controls in certain scenarios.

### BRIEF SUMMARY

A method, apparatus, computer readable storage medium, user interface, and computer program product are provided in accordance with an example embodiment to determine and predict lingering communication indicators. In this regard, the method, apparatus, computer readable storage medium, and computer program product of an example embodiment may utilize data collected from and about end user communications and the end users' surroundings to determine and predict one or more lingering communication indicators. The reliance upon the collection and analysis of communication data may supplement the information provided by other sensors and allow for the provision of different information, such as the type of lingering communication and the end user's emotional response to said communication which is useful for a variety of applications. As an example, the determination of the location of a lingering communication indicator may be useful in relation to the provision of more relevant information. Such uses include routing information, alerts, real time route guidance, etc.

One embodiment may be described as a method for providing a lingering communication detection system comprising obtaining data of at least one electronic communication conducted by an end user and determining a lingering communication indicator based on the obtained data. The system may then identify one or more road segments and associate the determined lingering communication indicator with one or more identified road segments to update a map layer of a geographic database.

The method above may further include receiving an indication of a first location of the end user conducting the at least one electronic communication and a second location of the end user conducting the at least one electronic communication. The locations above may be homes, offices, etc. and include an indication of a location of a vehicle occupied by the end user.

The method above may yet further comprise determining a confidence interval associated with the lingering communication indicator and updating a map layer with the confidence interval. This confidence interval associated with the determined lingering communication indicator may be based at least in part on relationship metadata for the end user and a recipient of the at least one electronic communication. The confidence interval associated with the determined lingering communication indicator may also be based at least in part on biofeedback obtained from end users. Alerts and/or route guidance may be provided by this method and others in response to the determined lingering communication indicator, the alerts/guidance being sent to at least one end user device.

Another embodiment may be described as an apparatus configured to predict lingering communication indicators, the apparatus comprising at least one processor and at least one memory storing computer program code, the at least one memory and the computer program code configured to, with the processor, cause the apparatus to at least obtain data of at least one electronic communication conducted by an end user and determine a lingering communication indicator based on the obtained data. The apparatus may then identify one or more road segments and associate the lingering communication indicator with one or more identified road segments to update a map layer of a geographic database.

The apparatus, in one embodiment, may feature at least one memory and the computer program code which are further configured to, with the processor, cause the apparatus to receive an indication of a location of the end user at a first location and a second location. The indication of first location and/or second location may include an indication of a location of the end user within a vehicle. The apparatus may also determine a confidence interval associated with the previously determined lingering communication indicator and update a map layer with the confidence interval. The apparatus may also update the confidence interval associated with the determined indicator based at least in part on the indication of a location of the end user within a vehicle.

This apparatus and others may also feature at least one memory and computer program code which are configured to, with the processor, cause the apparatus to obtain the data of at least one electronic communication from a social media network (e.g., Twitter, Facebook, Instagram, Tik-Tok, Snapchat, iMessage, WhatsApp, etc.). This apparatus and others may also feature at least one memory and computer program code which are configured to, with the processor, cause the apparatus to generate route guidance.

Yet another embodiment may be described as a user interface (UI) for providing a user with a route to a destination, comprising the steps of receiving input upon a user device from the user that indicates a destination, accessing a geographic database to obtain data that represent roads in a region in which the user device is operating, determining a route to the destination by selecting road segments to form a continuous path to the destination, and displaying the determined route or portion thereof to the user, wherein the determined route avoids at least one road segment in response to a lingering communication indicator. This UI may determine the route for the vehicle which avoids one or more lingering communication indicators that are proximate to the location of the vehicle. This UI and others may also derive the lingering communication indicator, at least in part, from image data obtained via a vehicle camera system.

All this UI information may be displayed on an end user device (e.g., smartphone, tablet, etc.) and/or in a motor vehicle (e.g., upon a built-in vehicle display).

Also, a computer program product may be provided. For example, a computer program product comprising instructions which, when the program is executed by a computer, cause the computer to carry out the steps described herein.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a block diagram of a geographic database of an example embodiment of the apparatus;

FIG. 3A is a flowchart illustrating the operations performed, such as by the apparatus of FIG. 1, in order for an apparatus to identify a lingering communication indicator;

FIG. 3B is a flowchart illustrating the operations performed, such as by the apparatus of FIG. 1, in order to provide a graphical user interface and/or functions thereof;

FIG. 3C is a flowchart illustrating the operations performed, such as by the apparatus of FIG. 1, in order to train machine learning models to predict lingering communication indicators;

FIG. 4A is a graphical representation of an end user exiting their home and approaching their vehicle while conducting an on-going communication;

FIG. 4B is a graphical representation of a road upon which a passenger cars are present and the present apparatus is in use.

### DETAILED DESCRIPTION

Some embodiments of the present invention will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A system, method, apparatus, user interface, and computer program product are provided in accordance with an example embodiment to determine a lingering communication indicator based on various data sources. In order to determine lingering communication indicator(s), the system, method, apparatus, non-transitory computer-readable storage medium, and computer program product of an example embodiment are configured to obtain data of at least one end user electronic communication, more specifically an on-going (lingering) communication between an end user via talk, text, social media, video chat, etc. and determine a lingering communication indicator based on the obtained data about the communication(s). The communication data may be obtained from any number of sources including cellular network usage information, short message service (SMS) data, end user location data, social network data, camera systems (e.g., vehicle camera system, traffic cameras, etc.), audio data, and any other functionally useful sources. The system may also examine end user biofeedback data, speech patterns, writing patterns, etc. The system in this embodiment may then identify one or more road segments and associate the determined lingering communication indicator with one or more related road segments to update a map layer of a geographic database.

The system, apparatus, method, etc. described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, etc. configured to detect and predict lingering communications may similarly be embodied by the same or different server, computer workstation, distributed network of computing devices, personal computer, or other type of computing device.

Alternatively, the system, etc. may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

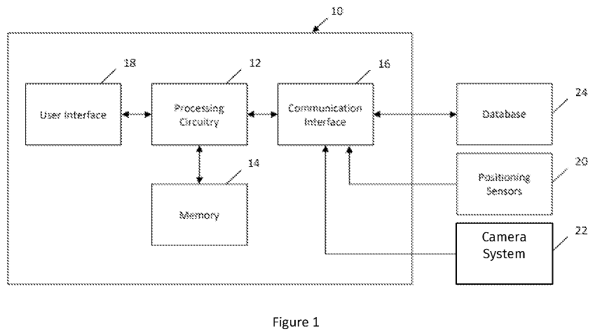

Regardless of the manner in which the system, apparatus, etc. is embodied, however, an apparatus 10 includes, is associated with, or is in communication with processing circuitry 12, memory 14, a communication interface 16 and optionally a user interface 18 as shown in FIG. 1. In some embodiments, the processing circuitry (and/or co-processors or any other processors assisting or otherwise associated with the processing circuitry) can be in communication with the memory via a bus for passing information among components of the apparatus. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally, or alternatively, the memory can be configured to store instructions for execution by the processing circuitry.

The processing circuitry 12 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally, or alternatively, the processing circuitry can include one or more processors configured in tandem via the bus to enable independent execution of instructions, pipelining and/or multithreading.

In an example embodiment, the processing circuitry 12 can be configured to execute instructions stored in the memory 14 or otherwise accessible to the processing circuitry. Alternatively, or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 10 of an example embodiment can also include the communication interface 16 that can be any means such as a device or circuitry embodied in either hardware or a combination of hardware and software that is configured to receive and/or transmit data from/to other electronic devices in communication with the apparatus, such as a database 24 which, in one embodiment, comprises a map database that stores data (e.g., one or more map objects, POI data, etc.) generated and/or employed by the processing circuitry 12. Additionally, or alternatively, the communication interface can be configured to communicate in accordance with various wireless protocols including Global System for Mobile Communications (GSM), such as but not limited to Long Term Evolution (LTE), 3G, 4G, 5G, 6G, etc. In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally, or alternatively, the communication interface can include the circuitry for interacting with the antenna(s) to cause transmission of signals via the antenna(s) or to handle receipt of signals received via the antenna(s). In some environments, the communication interface can alternatively or also support wired communication and/or may alternatively support vehicle to vehicle or vehicle to infrastructure wireless links.

In certain embodiments, the apparatus 10 can be equipped or associated with one or more positioning sensors 20, such as one or more GPS sensors, one or more accelerometer sensors, one or more light detection and ranging (LiDAR) sensors, one or more radar sensors, one or more gyroscope sensors, and/or one or more other sensors. Any of the one or more sensors may be used to sense information regarding movement, positioning and location, and/or orientation of the apparatus for use, such as by the processing circuitry 12, in navigation assistance and/or autonomous vehicle control, as described herein according to example embodiments.

In certain embodiments, the apparatus 10 may further be equipped with or in communication with one or more camera systems 22. In some example embodiments, the one or more camera systems 22 can be implemented in a vehicle or other remote apparatuses. The camera systems 22 may include systems which capture both image data and audio data (via a microphone, etc.).

For example, the one or more camera systems 22 can be located upon a vehicle or proximate to it (e.g., traffic cameras, etc.). While embodiments may be implemented with a single camera such as a front facing camera in a consumer vehicle, other embodiments may include the use of multiple individual cameras at the same time. A helpful example is that of a consumer sedan driving down a road. Many modern cars have one or more cameras installed upon them to enable automatic braking and other types of assisted or automated driving. Many cars also have rear facing cameras to assist with automated or manual parking. In one embodiment of the current system, apparatus, method, etc. these cameras are utilized to capture images and/or audio of end users, vehicles, streets, etc. as an end user travels/moves around. The system, apparatus, etc. takes these captured images and/or audio (via the camera systems 22) and analyzes them along with other relevant data to determine if there are lingering communication indicators present for an end user on a certain street, area, etc. It should be noted that various types of end user communication may be detected via any functional means.

The data captured concerning an end user's ongoing communications may also come from traffic cameras, security cameras, or any other functionally useful source (e.g., historic data, satellite images, websites, etc.).

The analysis of the image data, audio data, and other relevant data concerning end user communications, location, etc. may be carried out by a machine learning model. This model may utilize any functionally useful means of analysis to identify lingering communication indicators on a given roadway, road segment, or in a general area. The system, in this embodiment, may also examine relevant proximate points of interest (POIs), map objects, road geometries, animate objects, etc. which could suggest the presence of potential lingering communication indicators.

The locations of an end user, their vehicle, any relevant points of interest (POIs), and other types of data which are utilized by various embodiments of the apparatus may each be identified in latitude and longitude based on a location of the end user and their vehicle using a sensor, such as a GPS sensor to identify the location of the end user's device (e.g., smart phone, smart watch, tablet, etc.) and/or the end user vehicle. The POIs, map objects, infrastructure, etc. identified by the system may also be detected via the camera systems 22.

In certain embodiments, information detected by the one or more cameras can be transmitted to the apparatus 10, such as the processing circuitry 12, as image data and/or audio data. The data transmitted by the one or more cameras, microphones, etc. can be transmitted via one or more wired communications and/or one or more wireless communications (e.g., near field communication, or the like). In some environments, the communication interface 16 can support wired communication and/or wireless communication with the one or more system sensors (e.g., cameras, etc).

The apparatus 10 may also optionally include a user interface 18 that may, in turn, be in communication with the processing circuitry 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 14, and/or the like).

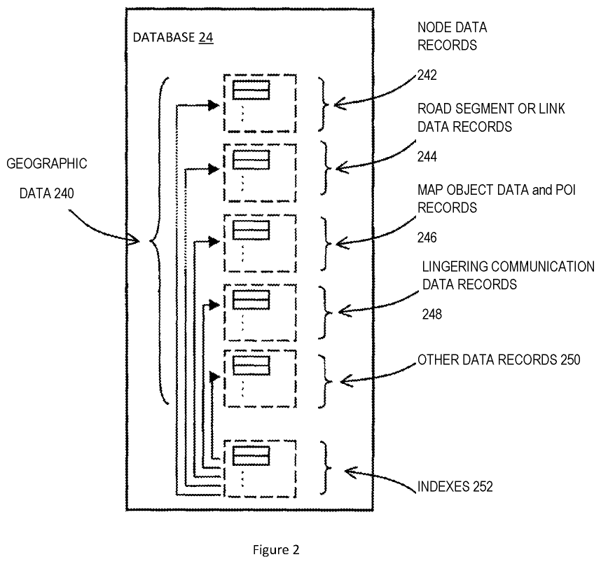

Turning to FIG. 2, the map or geographic database 24 may include various types of geographic data 240. This data may include but is not limited to node data 242, road segment or link data 244, map object and point of interest (POI) data 246, lingering communication data records 248, or the like (e.g., other data records 250 such as traffic data, sidewalk data, etc.). Other data records may include computer code instructions and/or algorithms for executing a machine learning model that is capable of providing a prediction of adverse road locations (as caused by the presence of lingering communication distractions). The other records may further include verification data indicating: (1) whether a verification of a prediction for an adverse road location was conducted; (2) whether the verification validates the prediction; or (3) a combination thereof.

In one embodiment, the following terminology applies to the representation of geographic features in the database 24. A “Node”—is a point that terminates a link, a “road/line segment”—is a straight line connecting two points, and a “Link” (or “edge”) is a contiguous, non-branching string of one or more road segments terminating in a node at each end. In one embodiment, the database 24 follows certain conventions. For example, links do not cross themselves and do not cross each other except at a node. Also, there are no duplicated shape points, nodes, or links. Two links that connect each other have a common node.

The map database 24 may also include cartographic data, routing data, and/or maneuvering data as well as indexes 252. According to some example embodiments, the road segment data records may be links or segments representing roads, streets, or paths, as may be used in calculating a route or recorded route information for determination of one or more personalized routes. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The map database 24 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The map database 24 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 24 may be a master geographic database, but in alternate embodiments, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example. It should be noted the map database 24 may also include data regarding the interiors of buildings, homes, offices, etc. to aid the system, apparatus, etc. in tracking end user location as the end user moves around one location or between locations.

The records for lingering communication data 248 may include various points of data such as, but not limited to: the type of communication, length of communication, location of the of the communication, metadata about those involved in the conversation, biofeedback data about end users (e.g., increased heart rate, blood pressure, etc.), etc.

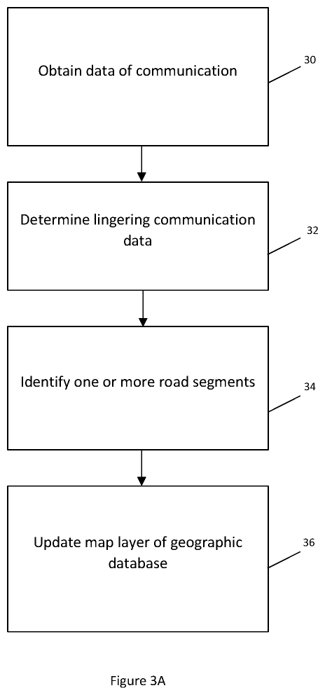

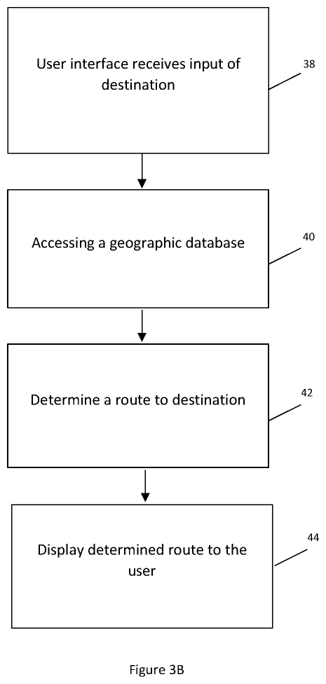

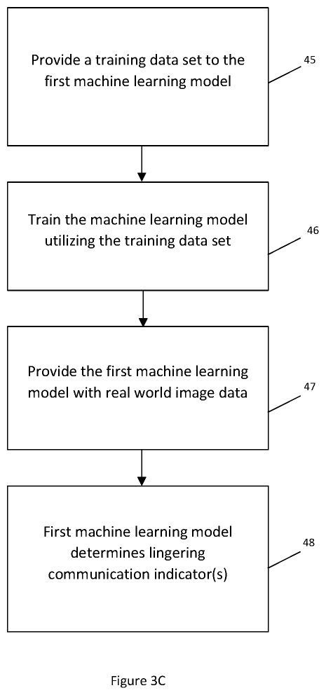

FIG. 3A is a flowchart which demonstrates how the apparatus 10 identifies lingering communications and indicators thereof. More, fewer, or different acts or steps may be provided. At a first step (block 30) the apparatus may obtain one or more images, audio, or other data of at least one end user communication. This data may be obtained from the end user device via the camera and microphone of a device such as a smart phone. Data may also be obtained from various programs, apps, websites, etc., running on said end user device such as messaging apps, social media networks, etc. Data may also be captured from the camera system of a vehicle or even traffic cameras, etc. The apparatus may be trained to analyze the data (see FIG. 3C) via machine learning model or any other functionally capable means to identify lingering communication indicators.

The data captured by the system may include but is not limited to the content and context of end user electronic communications, metadata about the relationship between those involved in each communication, length of the communication, locations of the communication, end user biofeedback data, actual images or audio data of end users utilizing their end user device in various contexts (e.g., within their home or office, approaching their vehicle, in their vehicle, etc.). The presently disclosed system, apparatus, etc. may monitor for any number of types of lingering communication which may result in distracted driving. Some examples may include arguments, heated discussions, or other ongoing conversations that begin in one location and are then continued within a vehicle.

The presence of the listed forms of lingering communication and others may result in distracted driving thus their presence, when detected upon or proximate to a road link by the apparatus 10, may be noted. Some events, such as world events or personally significant events, may commonly generate lingering communications and the apparatus 10 may also note the presence of such events as additional and/or separate lingering communication indicators. One example could be an end user getting engaged (to be wed) at home or in a restaurant. The end user may update their social media account(s) or communicate the significant life event to others via SMS on their end user device. The posting of this news on social media and/or texting friends to let them know the happy news may result in one or more ongoing communications via text, social media, etc. The incoming messages from social media in response to the engagement post and/or congratulation texts may be monitored by the apparatus 10.

Once this data (e.g., the ongoing messages) is obtained, the apparatus 10 may then determine the presence of lingering communication data at another step (block 32). For example, if the newly engaged end user leaves their home/a restaurant and enters their vehicle (confirmed by image data, geolocation data, NFC data, nearby hotspots, etc.) the apparatus 10 will note the presence of various incoming social media responses, etc. for the end user combined with the end user now occupying a car to denote the presence of one or more lingering communications.

Once one or more lingering communications has been identified, the apparatus may then identify one or more road segments (block 34) upon which the end user engaged in lingering communication(s) is traveling. The identification of the relevant road segments may be done via a vehicle's onboard GPS (see FIG. 1) or any other functional means. Once identified, the apparatus may then update a map layer of a geographic database (block 36).

The updating of the map layer may include but is not limited to identifying/associating locations of the identified relationships with certain road segments and then providing a data indicator or flag to mark that road segment or attribute (metadata) that can be used as an identifier when needed to access or retrieve the road segments for various navigation functions. This data can also be used to generate alerts and analyze other similarly situated road segments for the potential risk, route changes, etc. a given indicator might pose. The road segment data may also include sidewalk data or areas included in/associated with the road segment records or the road segment records may represent path records such as sidewalks, hiking trails, etc.

Turning to FIG. 3B, the apparatus 10 may support a user interface 18 (as shown in FIG. 1). More, fewer, or different acts or steps may be provided. At a first step, the user interface may receive an input of destination from an end user (block 38). This input of destination may be received via an end user device graphical user interface (GUI) running upon a smartphone, tablet, integrated vehicle navigation system, etc. Once a destination is input, the apparatus may then access a geographic database (block 40) and determine a route to the input destination (block 42). The determined route may, in some embodiments, avoid at least one road segment in response to a determined lingering communication indicator. As mentioned above, the determination of indicator may be based on any functionally capable means including identification of an actual ongoing conversations conducted by an end user in multiple locations (e.g., stared in a home and continued in a car), or a prediction of such lingering communications triggered by significant world/life events, end user feedback, and/or various other data sources.

Notwithstanding how the apparatus generates a determination of a lingering communication indicator, this information may then be used to route the end user towards or away from certain road segments when generating a route. The route determined by the apparatus 10 may then be displayed to the end user (block 44) via the same or a different user interface. The apparatus can take any number of additional actions (or in place of) what is called for in block 44. For example, the apparatus may provide audio guidance instead of a visual display. The navigation instructions may also be provided to an autonomous vehicle for routing (for example, without any display to the user). It should also be noted the UI can be run by a processor and stored upon one or more types of memory in some embodiments.

Referring now to FIG. 3C, the operations performed, such as by the apparatus 10 of FIG. 1, in order to train a machine learning model to detect and/or predict lingering communication indicators. More, fewer, or different acts or steps may be provided. As shown in block 45, the apparatus 10 includes means, such as the processing circuitry 12, memory 14, the communication interface 16 or the like, for providing a training data set that includes a plurality of training examples. In this regard, the training data set may be provided by access by the processing circuitry of the training data set stored by the memory. Alternatively, the training data set may be provided by access by the processing circuitry to a database 24 or other memory device that either may be a component of the apparatus or may be separate from, but accessible to the apparatus, such as the processing circuitry, via the communication interface. It should be noted the system apparatus may utilize more than one machine learning model to carry out the steps described herein.

In accordance with an example embodiment, the apparatus 10 also includes means, such as the processing circuitry 12, the memory 14 or the like, configured to train a machine learning model utilizing the training data set (block 46). The machine learning model, as trained, is configured to detect and predict lingering communication indicators. The prediction may be based, at least in part, upon data concerning an on-going conversation engaged in by at least one end user.

The apparatus 10, such as the processing circuitry 12, may train any of a variety of machine learning models to identify lingering communication indicators based upon a single or plurality of data points, images, audio, etc. Examples of machine learning models that may be trained include a decision tree model, a random forest model, a neural network, a model that employs logistic regression or the like. In some example embodiments, the apparatus, such as the processing circuitry, is configured to separately train a plurality of different types of machine learning models utilizing the same training data including the same plurality of training examples. After having been trained, the apparatus, such as the processing circuitry, is configured to determine which of the plurality of machine learning models predicts lingering communication indicators based upon image data with the greatest accuracy. The machine learning model that has been identified as most accurate is thereafter utilized.

In one example, the machine learning model may be a deep learning neural network computer vision model that utilizes communication data to automatically identify them as ongoing (lingering) communications. A training example for this first machine learning model may also include data demonstrating known types of distracting conversations such as arguments, enthusiastic discussions, sad discussions, etc. The content of the discussions may also be categorized. For example, discussions about topics like politics, personal relationships, sports, important world events, local news, etc. may elicit greater response, longer conversations, and/or more distraction while driving. These various types of discourse and metadata about them may be provided to the machine learning model to train and improve its accuracy.

In some example embodiments, a balance or trade-off between the accuracy with which the lingering communication indicators are identified and the efficiency with which the machine learning model identifies them is considered. For example, a first set of data, images, audio, etc. may produce the most accurate identification, but a second combination of data, images, audio, etc. may produce an identification of relevant communications (e.g., capitalized words, yelling on the phone, pacing while on the phone, etc.) that is only slightly less accurate, but that is significantly more efficient in terms of its prediction. Thus, the second combination of data that provides for sufficient, even though not the greatest, accuracy, but does so in a very efficient manner may be identified by the apparatus 10, such as the processing circuitry 12, as the preferred data about end user communications to be provided to the machine learning model to identify lingering communication indicators in subsequent instances.

In some embodiments, a training example also includes information regarding a map object, such as a map object that is located at the location at which the data concerning end user communication was captured. One example of a map object is a bridge, and another example of a map object is a railroad crossing. A wide variety of other map objects may exist including, for example, manhole covers, transitions between different types of road surfaces, medians, parking meters, various forms of infrastructure, or the like. As described in more detail below, the map object that is included in a training example may be determined or provided in various manners. For example, the map object may be defined, either manually or automatically, by reference to a map database 24 and identification of a map object at the same location or at a location proximate, such as within a predefined distance of, the location at which the corresponding image data was captured. The training example may also include point of interest (POI) data. A POI may be something like a hospital, restaurant, park, school, bus stop, etc. Relevant POIs may also be defined, either manually or automatically, by reference to a map database 24 and identification of a POI at the same location or at a location proximate, such as within a predefined distance of, the location at which the corresponding image data was captured. The location of relevant POIs and/or map objects may be found by GPS coordinates or any other functionally capable means.

Yet other various types of data may also be utilized when training the machine learning model including map geometry data, historic data, indoor mapping data, geolocation data, Wi-Fi mapping (e.g., triangulation) data, hotspot data, etc. Ground truth data may also be utilized with a combination of these different features for supervised machine learning.

It should also be noted in some examples the apparatus, system, etc. may monitor both sides of a conversation. As mentioned above, the apparatus may examine one end user's inputs, posts, text messages, speaking volume, etc. to determine if they are agitated or in an emotionally heightened state which might lead to distracted driving. In some embodiments, the apparatus may monitor and analyze this same data (and other information) for one or more additional end user to determine if any other end user, engaged in a conversation with the first end user, may also be distracted by the heated conversation and thus potentially be distracted while driving.

Once trained, the machine learning model may then be provided various real-world data as mentioned in block 47 and used to determine lingering communication indicators based on the various data points above and others (block 48).

An example of the apparatus 10 detecting and/or predicting a lingering communication indicator is that of an end user receiving bad news about a family member. The end user may receive a text from their parent stating “Aunt May is Sick!”. The apparatus 10 may observe the actual content of the text message and compare it to one of more databases of known communications to determine if this message has the potential to create a lingering communication. The system may also observe the end user's response to the message. For example, if the end user responds: “Oh no!” there is an indication that this conversation is upsetting to the end user. The level of physical response to a given message or conversation may also be monitored by the apparatus 10 via an end user's smart watch, phone accelerometers, etc. In this example, the end user not only responds with an exclamation but also has an increase in blood pressure and heart rate (as measured by their smart watch) and also immediately begin moving rapidly towards their front door (as measured by their phone or watch accelerometer combined with indoor mapping and location data).

The end user may then approach and enter a vehicle. The apparatus 10 may keep track of the end user by way of geolocation data, image data of the end user entering a vehicle captured by a camera system, an end user device pairing with vehicle Bluetooth or Wi-Fi of a vehicle, etc. As the end user drives their vehicle (e.g., a car) down a given road link, the apparatus 10 may continue to observe the end user to determine if the potentially distracting conversation is on-going. The apparatus 10 may achieve this by any functional means including continuing to monitor text messages, social media posts, etc. to establish the presence of a lingering communication in the form of a protracted conversation, argument, etc.

One such lingering communication, in this example, is the on-going text conversation between the end user (now driving a car) and their parent. The type of lingering communication determination and relevant other information identified by the apparatus may be provided to a machine learning model. The machine learning model will then be able to predict if and where distracted driving (caused by the lingering conversation) may occur on a given roadway. In this example, since the car is driven by someone who received bad news from a close family member about a relative and the end user had a physical response to the message, there is a likelihood that they will be distracted by the conversation if it continues as they drive down a given roadway.

The machine learning model in this example makes its determination based on a combination of specific factors (map data, communication data, image data, etc.), and the model predicts the potential for a lingering communication interaction because of specific factors in a specific combination or configuration are present. The factors in this example may include data extracted from the upsetting text sent to an end user, the end user's physical response, image data of the end user leaving their home and entering a vehicle, image data of the roadways, image data of other vehicles on the roadway, as well as time of day data, historic data, etc. This set of data, provided to the model, matches (or is like) the factors used in the training process (in this example). This allows the machine learning model to predict if lingering communication (e.g., an on-going emotional text/talk-to-text based conversation) is likely to occur location given the location, time of day, vehicles, end users present, etc.

The determination of the presence of lingering communication indicators can then be utilized in various ways. The apparatus 10 may alert the driver of the sedan (and other end users) via graphical user interface that there could be a risk ahead. The apparatus may also update one or more map layers and/or databases to account for this determination. In some embodiments, the identified location of a potentially distracting lingering communication may be used to activate autonomous or highly assisted driving features. For example, if the vehicle discussed above had self-driving capabilities the apparatus 10 could activate the self-driving mode in response to the lingering communication indicators to avoid potential distracted driving.

The determined lingering communication indicator(s) may be utilized in other ways. For example, the apparatus 10 may provide to the end users updated route guidance which avoids certain areas with potentially distracted drivers. Continuing with the example above, the apparatus 10 may look at existing map data to determine a better route which avoids the emotional/distracted driver(s) all together.

As mentioned before, the apparatus 10 features one or more machine learning models. This model and other data may be used by the apparatus 10 to not only analyze real time driving situations as mentioned above but also examine existing map data to identify other similarly situated roadways. These similar roadways will have similar POIs, map objects, etc. So, for example, if there was a roadway with which leads to a hospital upon which lingering communications typically occur, the apparatus 10 may be able to detect similar roadways in other areas and provide alerts, route guidance, etc. to an end user to avoid the potential risk.

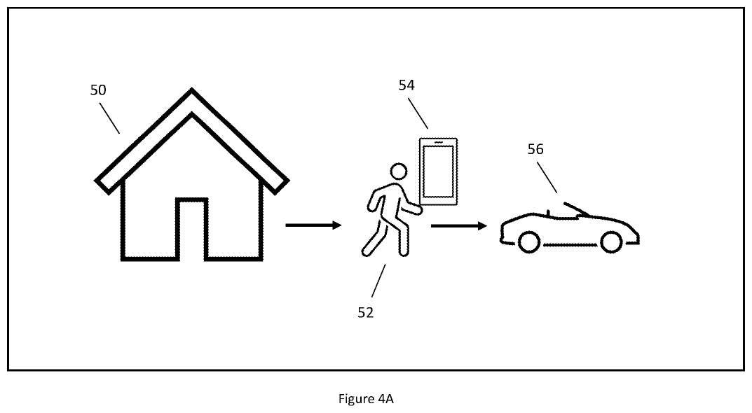

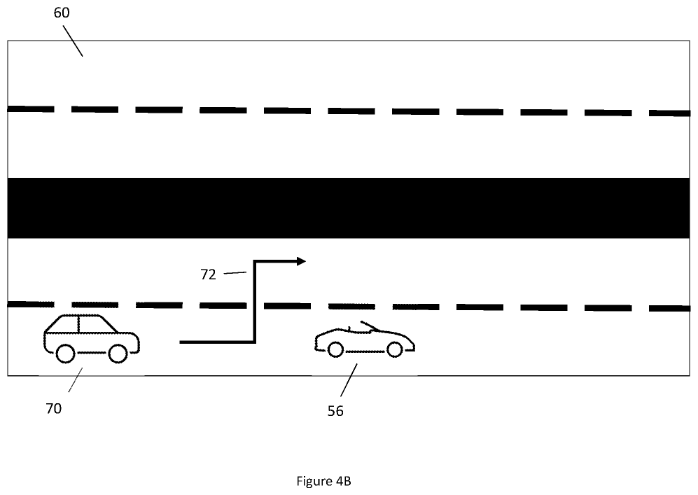

Turning to FIG. 4A, some of the examples discussed above are illustrated. Specifically, an end user 52 is shown exiting their home 50 and approaching their convertible 56. As shown in FIG. 4, the end user 52 is utilizing the apparatus 10 upon their end user device 54 to detect and/or predict lingering conversations. The apparatus 10 identifies the user's location (moving from house to car) via images from the camera system 22, traffic cameras, etc. and feeds those images into the machine learning model along with other data such as information concerning if the end user is currently engaged in an ongoing electronic conversation/interaction. The apparatus then takes this data along with relevant other information such as the image data of roads in the area, etc. and feeds all the data to the machine learning model (or to another model, algorithm, etc.) to determine if there is likely potential for an end user to engage in a lingering conversation/communication while operating their vehicle on a given roadway, sidewalk, trail, parking lot, etc.

It should be noted that the convertible 56 in this example represents any vehicle. Such vehicles may be standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, a graphical user interface (GUI) may be integrated in the vehicle, which may include assisted driving vehicles such as autonomous vehicles, highly assisted driving (HAD), and advanced driving assistance systems (ADAS). Any of these assisted driving systems may be incorporated into the GUI. Alternatively, an assisted driving device may be included in the vehicle. The assisted driving device may include memory, a processor, and systems to communicate with the GUI. In one embodiment, the vehicle may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In this example, the end user 52 has been in an argument on the social media platform Twitter concerning a recent sporting event. The end user has been regularly tweeting for several hours with other Twitter users about the same topic and have been sending increasingly emotional messages. In this example, the content of the messages need not be examined by the apparatus 10 and instead the interaction with Twitter is noted by the apparatus when the user posts on the app and their biofeedback in response to such an action. In this case, every time the end user 52 posts or responds to Twitter in the past few hours, their heart rate has increased shortly before and after. Based off this information, the apparatus 10 may deduce that the end user is an agitated or excited state. The end user in this example then exits their home 50 as confirmed by geolocation data, Wi-Fi data, image data, etc. and approaches their convertible while still using their end user device 54. Based on this information, the apparatus 10 may predict a high likelihood for distracted driving due to the various indicators of lingering communication present in this example (end user engaged in excited communication for an extended period in more than one location).

In some embodiments, the apparatus 10 may also extract information from the ongoing communications of an end user by use of OCR and/or NLP. In one embodiment, the apparatus 10 may use optical character recognition (“OCR”) in conjunction with one or more databases (see FIG. 2) to determine text or characters of a message. Additionally, the apparatus 10 may compare features or components (such as invariant components relating to an emoji) in or from images to reference features or components in one or more reference databases (or data libraries) to detect a symbol or feature (such as angry emojis, exclamation points, etc.). The apparatus 10 may then record (in a database) the determined text, the identified symbols and/or graphics thereof, and/or other features or determinations. For example, the end user 52 may be typing on their device 54 as they walk to their car an angry phrase such as “CHICAGO HAS A BAD TEAM!!”. The apparatus 10 can extract this text along with the exclamation points and any emojis used to determine the message's meaning and content, at least in part, by comparing the message's content to a current database of reference information.

As mentioned above, OCR may be used to extract the information from an end user message and natural language processing (NLP) technologies may be used in conjunction with the OCR tools to aid the apparatus 10 in analyzing the messages. NLP may be used in some embodiments to address issues around word segmentation, word removal, and summarization to determine the relevancy of the various parsed data. In various embodiments, semantics of the various parsed data are determined based on a vocabulary model in a grammar module. For example, in various embodiments, probabilistic latent semantic indexing (pLSI) or Latent Dirichlet allocation (LDA) may be used to deduce semantics from words in the extracted message information and determine the information's relevancy. Such methods can be used to derive text and topics from a set of predefined terms.

Based off this information, the apparatus may provide to the driver 52 of the convertible 56 an alert (e.g., a high-risk alert) that they are potentially distracted by their lingering communication. The information may also be used to provide route guidance 72 (see FIG. 4B below) or alerts to other user(s) in the area. The suggested route changes may mitigate the risk while in some other examples, automatic braking, etc. may be applied by the apparatus 10 to avoid higher risk situations is response to distracted driving.

Route guidance may include various guidance options, visual and/or audio. For example, visual guidance on how and when to change lanes or audio guidance relaying the same information. Automatic driver controls like those for an autonomous vehicle (e.g., an automatic lane change that can include an explanation to the passenger on what is happening), etc. The guidance itself can include the alert messages as mentioned above so the generation of alerts and route guidance can be the same function. When calculating the route and route guidance, metadata such as a data flag or attribute of road segments are taken into consideration when forming different suggested routes and one or more segments are excluded from these routes when it is determined (by the apparatus) that one or lingering communication indicators are associated with the omitted segment(s).

In some embodiments, apparatus 10 may generate a confidence interval/score which reflects the likelihood a given roadway or navigable link contains lingering communication indicator(s). In the example above, the apparatus 10 can detect an end user engaged in an on-going communication and extract relevant information such as the general tone of the conversation, etc. From the presence of this on-going communication, the confidence score for the likelihood of a lingering communication indicator on the given roadway may be increased from 0 to 0.5. The apparatus 10 may then receive additional information from other sources (e.g., metadata about the conversation, other cars present on a roadway, traffic camera data, traffic alerts, real-time driving behavior of the end user, etc.) which can increase or decrease this confidence score. For example, if there is image data of end user driving down the road and they are experiencing no disruptions/distraction to their driving behavior despite the detected on-going texts, social media alerts, etc. the apparatus 10 might lower the confidence score for the likelihood of lingering communication indicator(s) on the roadway from 0.5 to 0.25. Alternatively, if the end user is swerving or conducting the on-going conversation in a school zone or other high-risk area the confidence interval may be boosted up to 0.75 as the area the conversation is taking place and/or presence of bad driving indicates an increased risk caused by the lingering communication. This confidence interval can be updated in real time and is useful for numerous tasks including keeping an accurate record of potentially dangerous driving indicators and where they occur on roadways.

FIG. 4B illustrates another example embodiment. Specifically, the convertible 56 from FIG. 4A is shown driving down a roadway 60. The roadway 60 is also occupied by a sedan 70. As shown in FIG. 5, the sedan 70 is utilizing the apparatus 10 to predict if there are lingering communication indicators in the area. The apparatus 10 identifies the convertible 56 based on the information discussed above and feeds the data, images, etc. into a machine learning model which determines the presence of lingering communication indicators. The apparatus 10 then takes this data along with relevant other information and generates alerts, routing information, etc. In this example, the routing guidance 72 is shown as an arrow representing guidance to avoid the potentially distracted driver of the convertible 56 (e.g., a suggestion to drive around the distracted driver in the other lane).

As mentioned in the discussion for FIG. 4A, a confidence interval may be generated based on the likelihood that there are lingering communication indicators(s) present on a given roadway. With the instant example, the apparatus 10 may attribute a confidence score of 0.75 based on the presence of the convertible 56 and the various factors known about it (e.g., driver is currently arguing on Twitter and has been for several hours previously). This score can also be based in part on historical data concerning which vehicles and/or drivers most commonly engage in lingering communications. For example, teenagers are notorious for texting while driving (and distracted driving generally) so the confidence score, in this example, might be boosted up to 0.99 if the end user of the convertible is a teenager (who is also engaged in a protracted argument on social media across multiple physical locations).

As mentioned above, the apparatus 10 may also examine metadata concerning the relationships between the end user and who they are communicating with. Such metadata may be obtained from information on social media networks, contact information in phones or electronic address books, search engines, and/or extracted from the content of communications conducted by an end user. For example, if an end user is having a telephone conversation with someone and begins yelling the apparatus 10 may detect such heightened vocal volume by use of the phone's one or more microphones. The end user might also exclaim “Don't tell me that Dad!” allowing the apparatus to determine the end user is likely talking to their father which could result in a more protracted conversation and/or more distracted driving if the phone conversation was to be continued across multiple locations. By comparison, if the end user was speaking to the cable company (as discerned by the apparatus) they may be more (or less) distracted by such a conversation.

Lingering conversations with certain institutions or relationships might also be identified by the apparatus. For example, if people commonly experience protracted conversations and/or distracted driving when speaking with their spouse, children, etc. the apparatus 10 may be able to aggregate such data and identify these trends. These trends can then be used to tweak a confidence score for the presence of lingering communication on a given roadway up and down.

In a less invasive example, the apparatus 10 may only monitor the tone, treble, pitch, relative speaking volume, etc. of an end user along with their location at the start of a conversation and if they continue the conversation within a vehicle and/or second location. Certain tones, treble, pitch, relative speaking volume, etc. may be commonly associated with anger, excitement, etc. and the apparatus 10 may be able to predict the likelihood a given lingering conversation may distract an end user based on this data.

In another example, the apparatus 10 may also use metadata about a given conversation to predict the likelihood of lingering communication. For example, if someone gets a phone call at 3 AM from a hospital (as confirmed by caller ID) and the apparatus detects them rushing to their car while still on the phone there is a strong change of the end user staying on the phone (lingering communication) and thus the potential for distracted driving.

Yet other metadata can include information about certain POIs. For example, if an end user texts “I AM COMING TO THE PIZZA HUT NOW, WILL TEXT YOU ON THE WAY”. The content of the text (extracted by OCR, NLP, etc.) suggests urgency and the potential that the conversation might continue while they drive to a nearby Pizza Hut. The apparatus may examine one or more map databases to determine nearby relevant POIs, map objects, etc. and based on POI data, map data, etc. the apparatus 10 may generate route guidance and/or alerts in response which steers other vehicles clear of the area in which the Pizza Hut bound driver might be headed (e.g., the closest Pizza Hut to the texting end user as confirmed by GPS).

In yet another example, the apparatus 10 may also account for anyone who conducts a lingering conversation within a vehicle. A passenger who is upset, yelling, excited, etc. may also create a distraction for a driver and the apparatus 10 may also monitor end users who engage in conversation in one location and then move into a vehicle regardless of where they sit within said vehicle. The impact of a passenger conducting such an on-going conversation may be less risky than one conducted by a driver, but the various details about a given conversation may still indicate a likelihood of distracted driving.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an embodiment of the present invention and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing a lingering communication detection system comprising:
obtaining data of at least one electronic communication conducted by an end user;
determining a lingering communication indicator based on the obtained data;
identifying one or more road segments; and
associating the determined lingering communication indicator with one or more identified road segments to update a map layer of a geographic database.

2. The method according to claim 1, further comprising receiving an indication of a first location of the end user conducting the at least one electronic communication.

3. The method according to claim 1, further comprising receiving an indication of a second location of the end user conducting the at least one electronic communication.

4. The method according to claim 3, further comprising receiving an indication of a location of a vehicle occupied by the end user.

5. The method according to claim 1, further comprising determining a confidence interval associated with the lingering communication indicator and updating a map layer with the confidence interval.

6. The method according to claim 5, further comprising updating the confidence interval associated with the determined lingering communication indicator based at least in part on relationship metadata for the end user and a recipient of the at least one electronic communication.

7. The method according to claim 5, further comprising updating the confidence interval associated with the determined lingering communication indicator based at least in part on biofeedback from the end user.

8. The method according to claim 1, further comprising providing an alert and/or route guidance in response to the determined lingering communication indicator to at least one end user device.

9. An apparatus configured to predict lingering communication indicators, the apparatus comprising at least one processor and at least one memory storing computer program code, the at least one memory and the computer program code configured to, with the processor, cause the apparatus to at least:
obtain data of at least one electronic communication conducted by an end user;
determine a lingering communication indicator based on the obtained data;
identify one or more road segments; and
associate the lingering communication indicator with one or more identified road segments to update a map layer of a geographic database.

10. The apparatus according to claim 9, wherein the at least one memory and the computer program code are further configured to, with the processor, cause the apparatus to receive an indication of a location of the end user at a first location.

11. The apparatus according to claim 10, wherein the at least one memory and the computer program code are further configured to, with the processor, cause the apparatus to receive an indication of a location of the end user at a second location.

12. The apparatus according to claim 11, wherein the at least one memory and the computer program code are further configured to, with the processor, cause the apparatus to receive an indication of a location of the end user within a vehicle.

13. The apparatus according to claim 12, further comprising determining a confidence interval associated with the determined lingering communication indicator and updating a map layer with the confidence interval.

14. The apparatus according to claim 13, further comprising updating the confidence interval associated with the determined lingering communication indicator based at least in part on the indication of a location of the end user within a vehicle.

15. The apparatus according to claim 9, wherein the at least one memory and the computer program code are configured to, with the processor, cause the apparatus to obtain the data of at least one electronic communication from a social media network.

16. The apparatus according to claim 9, wherein the at least one memory and the computer program code are configured to, with the processor, cause the apparatus to generate route guidance.

17. A user interface for providing a user with a route to a destination, comprising the steps of:
receiving input upon a user device from the user that indicates a destination;
accessing a geographic database to obtain data that represent roads in a region in which the user device is operating;
determining a route to the destination by selecting road segments to form a continuous path to the destination; and
displaying the determined route or portion thereof to the user,
wherein the determined route avoids at least one road segment in response to a lingering communication indicator.

18. The user interface of claim 17, wherein the route determined for the vehicle avoids one or more lingering communication indicators proximate to the location of the vehicle.

19. The user interface of claim 17, wherein the lingering communication indicator is derived at least in part from image data obtained via a vehicle camera system.

20. The user interface of claim 17, wherein the user interface is displayed in a motor vehicle.
